(19) United States
(12) Patent Application Publication
(10) Pub. No.: US 2026/0200019 A1
(43) Pub. Date: Jul. 16, 2026

(54) METHOD FOR INCREASING HARDENED LAYER THICKNESS OF A RAIL HEAD OF A FLASH WELDED JOINT OF A STEEL RAIL AND A STEEL RAIL

(71) Applicants: PANGANG GROUP PANZHIHUA IRON & STEEL RESEARCH INSTITUTE CO., LTD., Panzhihua (CN); CHENGDU ADVANCED METAL MATERIALS INDUSTRY TECHNOLOGY RESEARCH INSTITUTE CO., LTD., Chengdu (CN)

(72) Inventors: Xin LU, Panzhihua (CN); Dadong LI, Panzhihua (CN); Jian DENG, Panzhihua (CN); Jie HUANG, Panzhihua (CN)

(21) Appl. No.: 18/861,803

(22) PCT Filed: May 29, 2024
(86) PCT No.: PCT/CN2024/095876

§ 371 Date: Oct. 30, 2024

(30) Foreign Application Priority Data
Sep. 7, 2023 (CN) 202311153004.9

(51) Int. Cl. B23K 37/003; B23K 11/00; B23K 11/04; B23K 101/26; C21D 1/18; C21D 9/04; C21D 9/50; C22C 38/00; C22C 38/02; C22C 38/04; C22C 38/24

(52) U.S. Cl. CPC B23K 37/003; B23K 11/0073; B23K 11/04; C21D 1/18; C21D 9/04; C21D 9/505; C22C 38/002; C22C 38/02; C22C 38/04; C22C 38/24; B23K 2101/26; C21D 2211/009

(57) ABSTRACT

A method for increasing hardened layer thickness of a rail head of a flash welded joint of a steel rail and a steel rail is provided. The method includes carrying out a flash welding on the steel rail, which includes sequentially carrying out an energization heating stage and a pressurizing and upsetting stage; wherein the energization heating stage has a voltage of 300~385V, an average current of 500~800 A, and a duration time of 80~100 s; and carrying out a heat treatment on the flash welded steel rail, which includes carrying out an accelerated cooling on a top surface of the rail head, a side surface of the rail head and a lower jaw of the rail head in a near welding seam area of the steel rail joint, the accelerated cooling has an initial temperature greater than 700° C., a final temperature of 430° C.~500° C., and an average cooling speed of 5~35° C./s.

### CROSS-REFERENCE TO RELATED APPLICATION

This application is a US national phase application of international application No. PCT/CN2024/095876, filed on May 29, 2024, which claims priority to Chinese Patent Application No. 202311153004.9, filed on Sep. 7, 2023. Both applications are incorporated herein by reference in their entireties.

### FIELD

The present application relates to the technical field of rail welding, and in particular to a method for increasing hardened layer thickness of a rail head of a flash welded joint of a steel rail and a steel rail.

### BACKGROUND

Steel rails are the most important part of railway lines, a service environment of heavy axle load and high frequency puts forward higher requirements for their usage performances, which mainly reflect in wear resistance and fatigue performance. Studies have shown that the higher the hardness, the better the wear resistance, without considering other factors such as wheel-rail matching and wear mediums. Therefore, hardness value is usually used as one of the main indicators to measure the wear resistance of materials. Methods for characterizing the hardness of base materials of a steel rail are mainly tread hardness and section hardness, and methods for characterizing a joint of the steel rail are mainly tread hardness and longitudinal section hardness.

At present, mainstream welding method for the steel rail is flash welding. The flash welding for the steel rail is a resistance welding method, which utilizes heat generated by a current passing through the resistance of tiny contact points on a contact surface of the steel rail end and electric arc to heat the steel rail end to be welded, and applies a pressure to a joint of the steel rail end after an appropriate period of time, so that an entire area of a butting surface of the steel rail is firmly combined together at the same time. The flash welding for the steel rail has a high degree of automation and stable welding quality, and is a main method for on-site construction welding of continuous welded rail at home and aboard. The flash welding for the steel rail is mainly divided into a fixed type flash welding and a mobile flash welding according to its mode of production. The fixed type flash welding usually involves fixing a welding equipment in the factory building, so it is also generally referred to as a factory welding or base welding. The fixed type flash welding usually heats the steel rail by a way of short circuiting the steel rail directly and utilizing resistance heat, a heating process of which is not (or slightly) accompanied by a flash. At present, mobile flash welders that mainly and most widely used at home and abroad are K950 and YGH-1200TH type mobile flash welders. The K950 mobile flash welder can ensure a high quality and long lifetime of a welding machine head.

A technical problem to be solved urgently in this field is how to improve hardness of the flash welded joint of the steel rail to enhance the wear resistance and fatigue performance of the steel rail.

### SUMMARY

A primary object of the present disclosure is to provide a method for increasing hardened layer thickness of a rail head of a flash welded joint of a steel rail and a steel rail, so as to solve the technical problem of how to improve hardness of the flash welded joint of the steel rail.

According to one aspect of the present disclosure, a method for increasing hardened layer thickness of a rail head of a flash welded joint of a steel rail is provided, and the method comprises following steps:
carrying out a flash welding on the steel rail, which includes sequentially carrying out an energization heating stage and a pressurizing and upsetting stage; wherein the energization heating stage has a voltage of 300~385V, an average current of 500~800 A, and a duration time of 80~100 s; and
carrying out a heat treatment on the flash welded steel rail, which includes carrying out an accelerated cooling on a top surface of the rail head, a side surface of the rail head and a lower jaw of the rail head in a near welding seam area of the steel rail joint, wherein the accelerated cooling has an initial temperature greater than 700° C., a final temperature of 430° C.~500° C., and an average cooling speed of 5~35° C./s.

According to one embodiment of the present disclosure, the energization heating stage has an opposite pressure of 20~130 kN applied to both ends of the steel rail to be welded, and a consumption of the steel rail of 8~20 mm.

According to one embodiment of the present disclosure, the step of carrying out a flash welding on the steel rail also includes carrying out a bead pushing stage after the pressurizing and upsetting stage, and it lasts for 5~10 s from end of the pressurizing and upsetting stage to complete end of the bead pushing stage.

According to one embodiment of the present disclosure, during the entire flash welding process, the steel rail on both sides in an area of 0~25 mm from an end face of the steel rail to be welded has a temperature of 900~1650° C., and the entire flash welding process has a duration time of 100~200 s.

According to one embodiment of the present disclosure, the energization heating stage has a voltage of 300V, an average current of 500 A, and a duration time of 80 s; and the accelerated cooling has a final temperature of 430° C., and an average cooling speed of 5° C./s.

According to one embodiment of the present disclosure, the energization heating stage has a voltage of 385V, an average current of 800 A, and a duration time of 100 s; and the accelerated cooling has a final temperature of 500° C., and an average cooling speed of 35° C./s.

According to one embodiment of the present disclosure, the energization heating stage has a voltage of 356V, an average current of 600 A, and a duration time of 90 s; and the accelerated cooling has a final temperature of 480° C., and an average cooling speed of 25° C./s.

According to one embodiment of the present disclosure, the steel rail to be welded is a high-strength rail head hardened pearlite steel rail, wherein the steel rail has the following main chemical components: by mass fraction, 0.74%~0.86% of C element, 0.10%~0.60% of Si element, 0.75%~1.25% of Mn element, no more than 0.020% of both P element and S element, no more than 0.30% of Cr element, and no more than 0.01% of V element; the steel rail has a tensile strength of at least 1172 MPa at the track gauge corner, and a hardness greater than or equal to 370 HB at a position having a depth of 25 mm from an outer contour surface of the rail head.

According to another aspect of the present disclosure, a steel rail prepared by the method as described above is provided, wherein an interior region of the rail head of the near welding seam area of the steel rail has a hardness of 95%~110% of that of an interior region of a rail head of a steel rail base material, and the interior region of the rail head of the near welding seam area of the steel rail has a microstructure with a pearlite area proportion greater than or equal to 97%, wherein the interior region of the rail head is a region with a depth of 0~25 mm from the surface of the rail head.

In the method for increasing hardened layer thickness of a rail head of a flash welded joint of a steel rail according to embodiments of the present disclosure, by improving relevant parameters of the flash welding process (in particular parameters such as voltage, current, time and the like of the energization heating stage) and relevant parameters of the post-weld heat treatment process, the hardened layer thickness of the rail head of the flash welded joint of the steel rail can be increased, internal hardness of the rail head of the flash welded joint of the steel rail can be improved, and the wear resistance and service life of the steel rail welding joint can thus be improved.

### BRIEF DESCRIPTION OF THE DRAWINGS

In order to clearly illustrate technical schemes in embodiments of the present disclosure or in the prior art, attached drawings needed to be used in embodiments or in a description of the prior art will be briefly introduced below. Obviously, the attached drawings in the following description are only some embodiments of the present disclosure. For those of ordinary skill in the art, other attached drawings can also be obtained based on these attached drawings without paying creative work.

FIG. 1 shows a schematic diagram of an interior region of the rail head of the near welding seam area according to an embodiment of the present disclosure; and

FIG. 2 shows another schematic diagram of an interior region of the rail head of the near welding seam area according to an embodiment of the present disclosure.

### DETAILED DESCRIPTION

In order to make the aim, technical scheme and advantages of the present disclosure more clearly understood, embodiments of the present disclosure will be further illustrated in detail below in combination with specific embodiments and with reference to the attached drawings.

It should be noted that all expressions of “first” and “second” in the embodiments of the present disclosure are intended to distinguish between two non-identical entities or parameters with the same name. It can be seen that “first” and “second” are only for the convenience of expression and should not be understood as limitations on the embodiments of the present disclosure, which will not be explained one by one in subsequent embodiments.

The present disclosure provides a method for increasing hardened layer thickness of a rail head of a flash welded joint of a steel rail, comprising following steps:
carrying out a flash welding on the steel rail, which includes sequentially carrying out an energization heating stage and a pressurizing and upsetting stage; wherein the energization heating stage has a voltage of 300~385V, an average current of 500~800 A, and a duration time of 80~100 s; and
carrying out a heat treatment on the flash welded steel rail, which includes employing a special equipment to carry out an accelerated cooling on a top surface of the rail head, a side surface of the rail head and a lower jaw of the rail head in a near welding seam area of the steel rail joint, wherein the accelerated cooling has an initial temperature greater than 700° C., a final temperature of 430° C.~500° C., and an average cooling speed of 5~35° C./s.

In the embodiments of the present disclosure, by improving relevant parameters of the flash welding process (in particular parameters such as voltage, current, time and the like of the energization heating stage) and relevant parameters of the post-weld heat treatment process, the hardened layer thickness of the rail head of the flash welded joint of the steel rail can be increased, internal hardness of the rail head of the flash welded joint of the steel rail can be improved, and the wear resistance and service life of the steel rail welding joint can thus be improved.

The heat treatment is used to eliminate internal stress of welding joints, refine austenite grains, homogenize the structure, and improve strength and hardness of the welded joint. In addition to a basic function of the heat treatment mentioned above, the heat treatment in the present disclosure can also improve the internal hardness of the rail head of the flash welded joint of a deep hardened layer steel rail. After the steel rail welding is completed, the structure of a joint which is at a high temperature stage is an austenite structure. As the steel rail joint cools, the austenite structure will transform from austenite to pearlite, from austenite to martensite or bainite at different temperature stages and cooling speeds. The martensite and bainite are harmful structures in a pearlitic steel rail, which can significantly reduce service performance of the joint and affect safety of train operation. When the austenite is cooled to a temperature lower than start transformation temperatures of the bainite and martensite at a cooling speed greater than a critical cooling speed of the steel rail material, the harmful structures such as the martensite or bainite and the like will occur inside the joint. Therefore, the final temperature needs to be controlled to 430° C.~500° C. and the average cooling speed needs to be controlled to 5~35° C./s. At the same time, in order to ensure that the hardness of the joint in the centre of the rail head is improved, austenite needs to have a sufficiently large supercooling degree at a sufficiently high temperature. Therefore, the initial temperature of the accelerated cooling is greater than 700° C., and the accelerated cooling on the top surface of the rail head, the side surface of the rail head and the lower jaw of the rail head in the near welding seam area of the steel rail joint are carried out.

The phase transition process of metal materials is directly affected by the temperature of the steel rail joint, and the cooling/temperature rise speed. All the time, current, voltage, and pressure in the welding process mentioned above as well as all the heating temperatures, cooling/temperature rise speed, and cooling final temperatures in the heat treatment process specified in the present disclosure synergistically work to realize desired performances of the steel rail welded joint.

In some embodiments, the steel rail to be welded is a high-strength rail head hardened pearlite steel rail, wherein the steel rail has the following main chemical components: by mass fraction, 0.74%~0.86% of C element, 0.10%~0.60% of Si element, 0.75%~1.25% of Mn element, no more than 0.020% of both P element and S element, no more than 0.30% of Cr element, and no more than 0.01% of V element; the tensile strength at the track gauge corner which is 12.7 mm from tread and side surface of the rail head of the steel rail respectively is at least 1172 MPa, and the hardness at a position having a depth of 25 mm from an outer contour surface of the rail head is greater than or equal to 370 HB. In the prior art, the flash welded joint of the high-strength rail head hardened pearlite steel rail has low wear resistance and short service life. The present disclosure provides a method for increasing hardened layer thickness of a rail head of a flash welded joint of a steel rail to solve this problem.

In the embodiments of the present disclosure, by setting the voltage value, current value and time value as described above, during the energization heating stage, the steel rail to be welded is mainly heated by means of short-circuit contacting the steel rail to be welded in an energization state and utilizing a heat of contact short-circuit resistance as well as a heat generated by a small amount of lintel explosion formed between liquid metals at an end face of the steel rail to be welded.

In some embodiments, during the energization heating stage, an opposite pressure applied to both ends of the steel rail to be welded is 20~130 kN, and a consumption of the steel rail is 8~20 mm. Thereby, a state that an intermittent short-circuit and lintel explosion coexisting is maintained.

In some embodiments, the step of carrying out a flash welding on the steel rail also includes carrying out a bead pushing stage after the pressurizing and upsetting stage. By carrying out the bead pushing, a surface of the welding seam can be shaped beautiful, and a welding quality can be improved. An integrated profiling steel rail bead pushing mechanism can be employed to carry out the bead pushing. In some embodiments, a time from end of the pressurizing and upsetting stage to complete end of the bead pushing stage is 5~10 s, thereby the quality of the joint and effects of the subsequent post-weld heat treatment can be ensured.

In some embodiments, the flash welding process mainly includes four stages such as an electrode clamping stage, the energization heating stage, the pressurizing and upsetting stage as well as the rapid bead pushing stage and the like. During the entire flash welding process, an area of both sides of the steel rail which is 0~25 mm from an end face to be welded has a temperature of 900~1650° C., and the entire flash welding process has a duration time of 100~200 s.

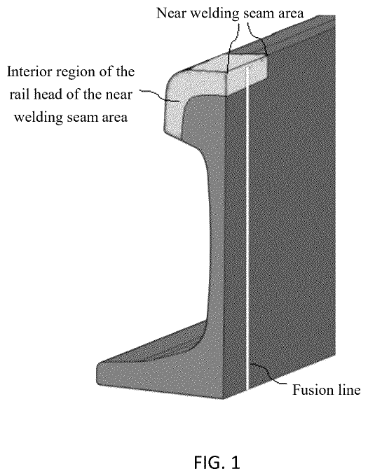

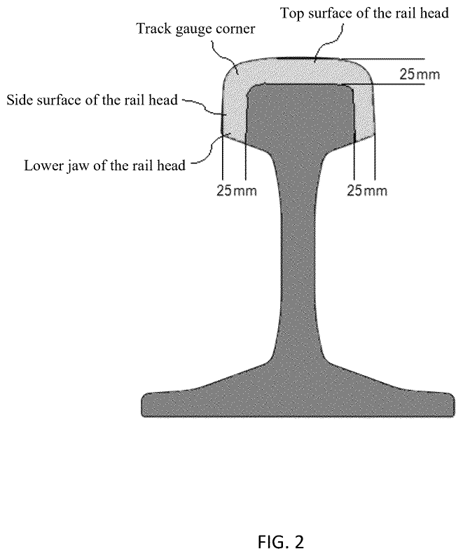

The present disclosure also provides a steel rail prepared by the method as described above. The hardness of an interior region of a rail head of the near welding seam area of a steel rail is 95%~110% of hardness of an interior region of a rail head of a steel rail base material, and the interior region of the rail head of the near welding seam area of the steel rail has a microstructure with a pearlite area proportion greater than or equal to 97%. Referring to FIG. 1 and FIG. 2, the near welding seam area (can also be called a near fusion line area) may be a heat affected zone which is 1~10 mm from both sides of the fusion line respectively; the interior region of the rail head may be a region with a depth of 0~25 mm from the surface of the rail head (may include regions of a top surface of the rail head, track gauge corner, both sides of the rail head and a lower jaw of the rail head which have a depth of 0~25 mm from the outer contour surface of the rail head).

In summary, the present disclosure mainly directs at the technical problem that the flash welded joint of the high-strength rail head hardened pearlite steel rail has reduced wear resistance and short service life, and provides a method for increasing hardened layer thickness of a rail head of a flash welded joint of a steel rail. The method includes two main processes of welding and post-weld heat treatment. The present disclosure improves the parameters of these two main processes, which can improve the hardness of the flash welded joint of the high-strength rail head hardened pearlite steel rail, thereby improving the wear resistance and service life.

The following is an explanation based on specific embodiments and comparative examples.

### Embodiment 1

The steel rail material used in this embodiment has the following main chemical components: by mass fraction, 0.74% of C element, 0.55% of Si element, 1.25% of Mn element, no more than 0.020% of both P element and S element, no more than 0.30% of Cr element, and no more than 0.01% of V element. The tensile strength at the track gauge corner which is 12.7 mm from tread and side surface of a rail head of a steel rail respectively is 1180 MPa~1280 MPa, and the hardness at a position having a depth of 25 mm from an outer contour surface of the rail head is 378 HB~391 HB. Two main processes of welding and post-weld heat treatment are used. The welding method is a steel rail flash welding, and the welding process mainly includes four stages comprising the electrode clamping stage, the energization heating stage, the pressurizing and upsetting stage as well as the rapid bead pushing stage and the like. During the entire welding process, the temperatures of both sides of the steel rail which are 0 mm~25 mm from an end face of the steel rail to be welded are 900° C.~1650° C., and the duration time is 100 s. During the heating stage of the welding process, the steel rail to be welded is mainly heated by means of short-circuit contacting the steel rail to be welded in an energization state and utilizing a heat of contact short-circuit resistance as well as a heat generated by a small amount of lintel explosion formed between liquid metals at an end face of the steel rail to be welded. The voltage of the heating stage is 300V, the average current of the heating stage is 500 A, and the duration time of the heating stage is 80 s. During the heating stage, an opposite pressure applied to both ends of the steel rail to be welded is 20 kN, and a consumption of the steel rail is 8 mm. During the rapid bead pushing stage of the welding process, an integrated profiling steel rail bead pushing mechanism is employed. The time from the end of the pressurizing and upsetting stage to the complete end of the bead pushing stage is 5 s. After the welding is completed, an accelerated cooling on a top surface of the rail head, a side surface of the rail head and a lower jaw of the rail head in a near welding seam area of the steel rail joint is carried out by employing a special equipment, wherein cooling initial temperatures of the top surface of the rail head, the side surface of the rail head and the lower jaw of the rail head are greater than 700° C., the average cooling speed during the accelerated cooling is 5° C./s, and the final temperature of the accelerated cooling is 430° C. Longitudinal section hardness tests are carried out on areas of 5 mm and 25 mm below a joint tread referring to AS1085.20 standard, and a microstructure inspection is carried out on the joint referring to BS EN14587. Results show that the ratio of the internal hardness of the rail head in the fusion line area of the joint to the hardness of the steel rail base material at the same position is 94%~97%, and the pearlite area proportion in the microstructure is approximately 99%.

### Embodiment 2

The steel rail material used in this embodiment has the following main chemical components: by mass fraction, 0.86% of C element, 0.60% of Si element, 1.25% of Mn element, no more than 0.020% of both P element and S element, no more than 0.30% of Cr element, and no more than 0.01% of V element. The tensile strength at the track gauge corner which is 12.7 mm from tread and side surface of a rail head of a steel rail respectively is 1280 MPa~1390 MPa, and the hardness at a position having a depth of 25 mm from an outer contour surface of the rail head is 390 HB~430 HB. Two main processes of welding and post-weld heat treatment are used. The welding method is a steel rail flash welding, and the welding process mainly includes four stages comprising the electrode clamping stage, the energization heating stage, the pressurizing and upsetting stage as well as the rapid bead pushing stage and the like. During the entire welding process, the temperatures of both sides of the steel rail which are 0 mm~25 mm from an end face of the steel rail to be welded are 900° C.~1650° C., and the duration time is 200 s. During the heating stage of the welding process, the steel rail to be welded is mainly heated by means of short-circuit contacting the steel rail to be welded in an energization state and utilizing a heat of contact short-circuit resistance as well as a heat generated by a small amount of lintel explosion formed between liquid metals at an end face of the steel rail to be welded. The voltage of the heating stage is 385V, the average current of the heating stage is 800 A, and the duration time of the heating stage is 100 s. During the heating stage, an opposite pressure applied to both ends of the steel rail to be welded is 130 kN, and a consumption of the steel rail is 8 mm~~20 mm. During the rapid bead pushing stage of the welding process, an integrated profiling steel rail bead pushing mechanism is employed. The time from the end of the pressurizing and upsetting stage to the complete end of the bead pushing stage is 10 s. After the welding is completed, an accelerated cooling on a top surface of the rail head, a side surface of the rail head and a lower jaw of the rail head in a near welding seam area of the steel rail joint is carried out by employing a special equipment, wherein cooling initial temperatures of the top surface of the rail head, the side surface of the rail head and the lower jaw of the rail head are greater than 700° C., the average cooling speed during the accelerated cooling is 35° C./s, and the final temperature of the accelerated cooling is 500° C. Longitudinal section hardness tests are carried out on areas of 5 mm and 25 mm below a joint tread referring to AS1085.20 standard, and a microstructure inspection is carried out on the joint referring to BS EN14587. Results show that the ratio of the internal hardness of the rail head in the fusion line area of the joint to the hardness of the steel rail base material at the same position is 107%~110%, and the pearlite area proportion in the microstructure is approximately 98%.

### Embodiment 3

The steel rail material used in this embodiment has the following main chemical components: by mass fraction, 0.78% of C element, 0.30% of Si element, 0.75% of Mn element, no more than 0.020% of both P element and S element, no more than 0.30% of Cr element, and no more than 0.01% of V element. The tensile strength at the track gauge corner which is 12.7 mm from tread and side surface of a rail head of a steel rail respectively is 1172 MPa~1250 MPa, and the hardness at a position having a depth of 25 mm from an outer contour surface of the rail head is 370 HB~387 HB. It includes two main processes of welding and post-weld heat treatment. The welding method is a steel rail flash welding, and the welding process mainly includes four stages such as the electrode clamping stage, the energization heating stage, the pressurizing and upsetting stage as well as the rapid bead pushing stage and the like. During the entire welding process, the temperatures of both sides of the steel rail which are 0 mm~25 mm from an end face of the steel rail to be welded are 900° C.~1650° C., and the duration time is 190 s. During the heating stage of the welding process, the steel rail to be welded is mainly heated by means of short-circuit contacting the steel rail to be welded in an energization state and utilizing a heat of contact short-circuit resistance as well as a heat generated by a small amount of lintel explosion formed between liquid metals at an end face of the steel rail to be welded. The voltage of the heating stage is 356V, the average current of the heating stage is 600 A, and the duration time of the heating stage is 90 s. During the heating stage, an opposite pressure applied to both ends of the steel rail to be welded is 100 kN, and a consumption of the steel rail is 14 mm. During the rapid bead pushing stage of the welding process, an integrated profiling steel rail bead pushing mechanism is employed. The time from the end of the pressurizing and upsetting stage to the complete end of the bead pushing stage is 8 s. After the welding is completed, an accelerated cooling on a top surface of the rail head, a side surface of the rail head and a lower jaw of the rail head in a near welding seam area of the steel rail joint is carried out by employing a special equipment, wherein cooling initial temperatures of the top surface of the rail head, the side surface of the rail head and the lower jaw of the rail head are greater than 700° C., the average cooling speed during the accelerated cooling is 25° C./s, and the final temperature of the accelerated cooling is 480° C. Longitudinal section hardness tests are carried out on areas of 5 mm and 25 mm below a joint tread referring to AS1085.20 standard, and a microstructure inspection is carried out on the joint referring to BS EN14587. Results show that the ratio of the internal hardness of the rail head in the fusion line area of the joint to the hardness of the steel rail base material at the same position is 98%~105%, and the pearlite area proportion in the microstructure is approximately 98%.

### Comparative Example 1

The steel rail material used in this comparative example has the following main chemical components: by mass fraction, 0.74% of C element, 0.55% of Si element, 1.25% of Mn element, no more than 0.020% of both P element and S element, no more than 0.30% of Cr element, and no more than 0.01% of V element. The tensile strength at the track gauge corner which is 12.7 mm from tread and side surface of a rail head of a steel rail respectively is 1180 MPa~1280 MPa, and the hardness at a position having a depth of 25 mm from an outer contour surface of the rail head is 378 HB~391 HB. It includes two main processes of welding and post-weld heat treatment. The welding method is a steel rail flash welding, and the welding process mainly includes four stages such as the electrode clamping stage, the energization heating stage, the pressurizing and upsetting stage as well as the rapid bead pushing stage and the like. During the entire welding process, the temperatures of both sides of the steel rail which are 0 mm~25 mm from an end face of the steel rail to be welded are 900° C.~1650° C., and the duration time is 250 s. During the heating stage of the welding process, the steel rail to be welded is mainly heated by means of short-circuit contacting the steel rail to be welded in an energization state and utilizing a heat of contact short-circuit resistance as well as a heat generated by a small amount of lintel explosion formed between liquid metals at an end face of the steel rail to be welded. The voltage of the heating stage is 400V, the average current of the heating stage is 900 A, and the duration time of the heating stage is 130 s. During the heating stage, an opposite pressure applied to both ends of the steel rail to be welded is 150 kN, and a consumption of the steel rail is 34 mm. During the rapid bead pushing stage of the welding process, an integrated profiling steel rail bead pushing mechanism is employed. The time from the end of the pressurizing and upsetting stage to the complete end of the bead pushing stage is 4 s. After the welding is completed, an accelerated cooling on a top surface of the rail head, a side surface of the rail head and a lower jaw of the rail head in a near welding seam area of the steel rail joint is carried out by employing a special equipment, wherein cooling initial temperatures of the top surface of the rail head, the side surface of the rail head and the lower jaw of the rail head are greater than 700° C., the average cooling speed during the accelerated cooling is 50° C./s, and the final temperature of the accelerated cooling is 380° C. Longitudinal section hardness tests are carried out on areas of 5 mm and 25 mm below a joint tread referring to AS1085.20 standard, and a microstructure inspection is carried out on the joint referring to BS EN14587. Results show that the ratio of the internal hardness of the rail head in the fusion line area of the joint to the hardness of the steel rail base material at the same position is 105%~130%, and the pearlite area proportion in the microstructure is greater than or equal to 70%. A large amount of martensite abnormal structure is detected in the joint, which does not meet use requirements.

### Comparative Example 2

The steel rail material used in this comparative example has the following main chemical components: by mass fraction, 0.86% of C element, 0.60% of Si element, 1.25% of Mn element, no more than 0.020% of both P element and S element, no more than 0.30% of Cr element, and no more than 0.01% of V element. The tensile strength at the track gauge corner which is 12.7 mm from tread and side surface of a rail head of a steel rail respectively is 1280 MPa~1390 MPa, and the hardness at a position having a depth of 25 mm from an outer contour surface of the rail head is 390 HB~430 HB. It includes two main processes of welding and post-weld heat treatment. The welding method is a steel rail flash welding, and the welding process mainly includes four stages such as the electrode clamping stage, the energization heating stage, the pressurizing and upsetting stage as well as the rapid bead pushing stage and the like. During the entire welding process, the temperatures of both sides of the steel rail which are 0 mm~25 mm from an end face of the steel rail to be welded are 900° C.~1650° C., and the duration time is 200 s. During the heating stage of the welding process, the steel rail to be welded is mainly heated by means of short-circuit contacting the steel rail to be welded in an energization state and utilizing a heat of contact short-circuit resistance as well as a heat generated by a small amount of lintel explosion formed between liquid metals at an end face of the steel rail to be welded. The voltage of the heating stage is 385V, the average current of the heating stage is 800 A, and the duration time of the heating stage is 100 s. During the heating stage, an opposite pressure applied to both ends of the steel rail to be welded is 130 kN, and a consumption of the steel rail is 8 mm~20 mm. During the rapid bead pushing stage of the welding process, an integrated profiling steel rail bead pushing mechanism is employed. The time from the end of the pressurizing and upsetting stage to the complete end of the bead pushing stage is 10 s. After the welding is completed, an accelerated cooling on a top surface of the rail head, a side surface of the rail head and a lower jaw of the rail head in a near welding seam area of the steel rail joint is carried out by employing a special equipment, wherein cooling initial temperatures of the top surface of the rail head, the side surface of the rail head and the lower jaw of the rail head are approximately 500° C., the average cooling speed during the accelerated cooling is 45° C./s, and the final temperature of the accelerated cooling is 400° C. Longitudinal section hardness tests are carried out on areas of 5 mm and 25 mm below a joint tread referring to AS1085.20 standard, and a microstructure inspection is carried out on the joint referring to BS EN14587. Results show that the ratio of the internal hardness of the rail head in the fusion line area of the joint to the hardness of the steel rail base material at the same position is 80%~90%, and the pearlite area proportion in the microstructure is greater than or equal to 98%. The joint has a low collapse phenomenon, which does not meet use requirements.

### Comparative Example 3

The steel rail material used in this comparative example has the following main chemical components: by mass fraction, 0.78% of C element, 0.30% of Si element, 0.75% of Mn element, no more than 0.020% of both P element and S element, no more than 0.30% of Cr element, and no more than 0.01% of V element. The tensile strength at the track gauge corner which is 12.7 mm from tread and side surface of a rail head of a steel rail respectively is 1172 MPa~1250 MPa, and the hardness at a position having a depth of 25 mm from an outer contour surface of the rail head is 370 HB~387 HB. It includes two main processes of welding and post-weld heat treatment. The welding method is a steel rail flash welding, and the welding process mainly includes four stages such as the electrode clamping stage, the energization heating stage, the pressurizing and upsetting stage as well as the rapid bead pushing stage and the like. During the entire welding process, the temperatures of both sides of the steel rail which are 0 mm~25 mm from an end face of the steel rail to be welded are 900° C.~1650° C., and the duration time is 190 s. During the heating stage of the welding process, the steel rail to be welded is mainly heated by means of short-circuit contacting the steel rail to be welded in an energization state and utilizing a heat of contact short-circuit resistance as well as a heat generated by a small amount of lintel explosion formed between liquid metals at an end face of the steel rail to be welded. The voltage of the heating stage is 356V, the average current of the heating stage is 600 A, and the duration time of the heating stage is 90 s. During the heating stage, an opposite pressure applied to both ends of the steel rail to be welded is 100 kN, and a consumption of the steel rail is 14 mm. During the rapid bead pushing stage of the welding process, an integrated profiling steel rail bead pushing mechanism is employed. The time from the end of the pressurizing and upsetting stage to the complete end of the bead pushing stage is 4 s. After the welding is completed, an accelerated cooling on a top surface of the rail head, a side surface of the rail head and a lower jaw of the rail head in a near welding seam area of the steel rail joint is carried out by employing a special equipment, wherein cooling initial temperatures of the top surface of the rail head, the side surface of the rail head and the lower jaw of the rail head are 800° C., the average cooling speed during the accelerated cooling is 55° C./s, and the final temperature of the accelerated cooling is 380° C. Longitudinal section hardness tests are carried out on areas of 5 mm and 25 mm below a joint tread referring to AS1085.20 standard, and a microstructure inspection is carried out on the joint referring to BS EN14587. Results show that the ratio of the internal hardness of the rail head in the fusion line area of the joint to the hardness of the steel rail base material at the same position is 117%~130%, and the pearlite area proportion in the microstructure is greater than or equal to 80%. A large amount of martensite abnormal structure is detected in the joint, which does not meet use requirements.

Those of ordinary skill in the art should understand that discussion of any of the above embodiments is merely exemplary and is not intended to imply that the scope disclosed in the embodiments of the present disclosure (including the claims) is limited to these examples. Under the concept of the embodiments of the present disclosure, technical features in above embodiments or different embodiments may also be combined and have many other variations of different aspects of the embodiments of the present disclosure as described above, which are not provided in detail for the sake of brevity. Therefore, any omission, modification, equivalent substitution, improvement and the like made within the spirit and principle of the embodiments of the present disclosure should be included in the protection scope of the embodiments of the present disclosure.

1. A method for increasing hardened layer thickness of a rail head of a flash welded joint of a steel rail, the method comprising:
carrying out a flash welding on the steel rail, which includes sequentially carrying out an energization heating stage and a pressurizing and upsetting stage; wherein the energization heating stage has a voltage of 300~385V, an average current of 500~800 A, and a duration time of 80~100 s; and
carrying out a heat treatment on the flash welded steel rail, which comprises carrying out an accelerated cooling on a top surface of the rail head, a side surface of the rail head and a lower jaw of the rail head in a near welding seam area of the steel rail joint, wherein the accelerated cooling has an initial temperature greater than 700° C., a final temperature of 430° C.~500° C., and an average cooling speed of 5~35° C./s.

2. The method according to claim 1, wherein the energization heating stage has an opposite pressure of 20~130 kN applied to both ends of the steel rail to be welded, and a consumption of the steel rail of 8~20 mm.

3. The method according to claim 1, wherein the step of carrying out a flash welding on the steel rail includes carrying out a bead pushing stage after the pressurizing and upsetting stage, and the bead pushing stage lasts for 5~10 s from an end of the pressurizing and upsetting stage to a complete end of the bead pushing stage.

4. The method according to claim 1, wherein during an entire flash welding process, the steel rail on both sides in an area of 0~25 mm from an end face of the steel rail to be welded has a temperature of 900~1650° C,, and the entire flash welding process has a duration time of 100~200 s.

5. The method according to claim 1, wherein the energization heating stage has a voltage of 300V, an average current of 500 A, and a duration time of 80 s; and the accelerated cooling has a final temperature of 430° C., and an average cooling speed of 5° C./s.

6. The method according to claim 1, wherein the energization heating stage has a voltage of 385V, an average current of 800 A, and a duration time of 100 s; and the accelerated cooling has a final temperature of 500° C., and an average cooling speed of 35° C./s.

7. The method according to claim 1, wherein the energization heating stage has a voltage of 356V, an average current of 600 A, and a duration time of 90 s; and the accelerated cooling has a final temperature of 480° C., and an average cooling speed of 25° C./s.

8. The method according to claim 1, wherein the steel rail to be welded is a high-strength rail head hardened pearlite steel rail, wherein the steel rail comprises: by mass fraction, 0.74%~0.86% of C element, 0.10%~0.60% of Si element, 0.75%~1.25% of Mn element, no more than 0.020% of both P element and S element, no more than 0.30% of Cr element, and no more than 0.01% of V element; the steel rail has a tensile strength of at least 1172 MPa at a track gauge corner, and a hardness greater than or equal to 370 HB at a position having a depth of 25 mm from an outer contour surface of the rail head.

9. A steel rail prepared by the method according to claim 1, wherein an interior region of the rail head of the near welding seam area of the steel rail has a hardness of 95%~110% of that of an interior region of a rail head of a steel rail base material, and the interior region of the rail head of the near welding seam area of the steel rail has a microstructure with a pearlite area proportion greater than or equal to 97%, wherein the interior region of the rail head is a region with a depth of 0~25 mm from the surface of the rail head.

10. A steel rail prepared by the method according to claim 2, wherein an interior region of the rail head of the near welding seam area of the steel rail has a hardness of 95%~110% of that of an interior region of a rail head of a steel rail base material, and the interior region of the rail head of the near welding seam area of the steel rail has a microstructure with a pearlite area proportion greater than or equal to 97%, wherein the interior region of the rail head is a region with a depth of 0~25 mm from the surface of the rail head.

11. A steel rail prepared by the method according to claim 3, wherein an interior region of the rail head of the near welding seam area of the steel rail has a hardness of 95%~110% of that of an interior region of a rail head of a steel rail base material, and the interior region of the rail head of the near welding seam area of the steel rail has a microstructure with a pearlite area proportion greater than or equal to 97%, wherein the interior region of the rail head is a region with a depth of 0~25 mm from the surface of the rail head.

12. A steel rail prepared by the method according to claim 4, wherein an interior region of the rail head of the near welding seam area of the steel rail has a hardness of 95%~110% of that of an interior region of a rail head of a steel rail base material, and the interior region of the rail head of the near welding seam area of the steel rail has a microstructure with a pearlite area proportion greater than or equal to 97%, wherein the interior region of the rail head is a region with a depth of 0~25 mm from the surface of the rail head.

13. A steel rail prepared by the method according to claim 5, wherein an interior region of the rail head of the near welding seam area of the steel rail has a hardness of 95%~110% of that of an interior region of a rail head of a steel rail base material, and the interior region of the rail head of the near welding seam area of the steel rail has a microstructure with a pearlite area proportion greater than or equal to 97%, wherein the interior region of the rail head is a region with a depth of 0~25 mm from the surface of the rail head.

14. A steel rail prepared by the method according to claim 6, wherein an interior region of the rail head of the near welding seam area of the steel rail has a hardness of 95%~110% of that of an interior region of a rail head of a steel rail base material, and the interior region of the rail head of the near welding seam area of the steel rail has a microstructure with a pearlite area proportion greater than or equal to 97%, wherein the interior region of the rail head is a region with a depth of 0~25 mm from the surface of the rail head.

15. A steel rail prepared by the method according to claim 7, wherein an interior region of the rail head of the near welding seam area of the steel rail has a hardness of 95%~110% of that of an interior region of a rail head of a steel rail base material, and the interior region of the rail head of the near welding seam area of the steel rail has a microstructure with a pearlite area proportion greater than or equal to 97%, wherein the interior region of the rail head is a region with a depth of 0~25 mm from the surface of the rail head.

16. A steel rail prepared by the method according to claim 8, wherein an interior region of the rail head of the near welding seam area of the steel rail has a hardness of 95%~110% of that of an interior region of a rail head of a steel rail base material, and the interior region of the rail head of the near welding seam area of the steel rail has a microstructure with a pearlite area proportion greater than or equal to 97%, wherein the interior region of the rail head is a region with a depth of 0~25 mm from the surface of the rail head.
